(19) United States
(12) Patent Application Publication
(10) Pub. No.: US 2024/0217662 A1
(43) Pub. Date: Jul. 4, 2024

(54) METHOD FOR USING AN AIR DISTRIBUTION SYSTEM IN A FUSELAGE

(71) Applicant: Airbus Operations GmbH, HAMBURG (DE)

(72) Inventor: Jens LOHMAR, HAMBURG (DE)

(21) Appl. No.: 18/532,378

(22) Filed: Dec. 7, 2023

(30) Foreign Application Priority Data
Dec. 30, 2022 (EP) 22217306.4

(51) Int. Cl. B64D 13/00

(52) U.S. Cl. CPC B64D 13/00

(57) ABSTRACT

A method for using an air distribution system in a fuselage, comprising the following method steps: providing an air distribution system which has an air distribution line, which is formed at least in part from a fluid-tight and flexible material, wherein the air distribution line is configured to switch from a first state in which the flexible material is substantially taut to a second state in which the flexible material is substantially slack, arranging the air distribution line in a place of installation in the fuselage, occupying the first state of the air distribution line in order to operate the air distribution system, or occupying the second state of the air distribution line in order to carry out maintenance in a spatial region near the place of installation.

### CROSS-REFERENCES TO RELATED APPLICATIONS

This application claims the benefit of the European patent application No. 22217306.4 filed on Dec. 30, 2022, the entire disclosures of which are incorporated herein by way of reference.

### FIELD OF THE INVENTION

The invention relates to a method for using an air distribution system in a fuselage.

### BACKGROUND OF THE INVENTION

Air distribution systems of this type are used as a component of aircraft air-conditioning systems which are used to set and maintain the desired ambient conditions in the aircraft cabin, for example the pressure, the temperature and the humidity of the cabin.

The cabin of a passenger aircraft is conventionally air conditioned both during flight operations and during ground operations of the aircraft by means of an on-board air-conditioning system. Bleed air taken off, for example from the engine compressors or auxiliary engine compressors, is supplied to the aircraft air-conditioning system, which bleed air is cooled to a desired low temperature in the air-conditioning units, known as the air-conditioning packs of the aircraft air-conditioning system. The air cooled in the air-conditioning packs of the aircraft air-conditioning system is conducted into a mixer, where it is mixed with recirculated air sucked out of the aircraft cabin. The mixed air produced in the mixer from cold fresh air provided by the air-conditioning packs and recirculated air extracted from the aircraft cabin is lastly conducted into the aircraft cabin to air-condition the aircraft cabin.

In conventional aircraft air-conditioning systems, the mixed air produced is conducted into the aircraft cabin by means of an air distribution system. Since the central mixers are typically arranged in the lower deck region, in particular in the region of what is known as the “belly fairing” of the aircraft (approximately in the front region of the center wing box), the mixed air reaches the passenger regions in the upper deck of the aircraft firstly via longitudinally extending air distribution ducts and then via riser ducts.

Alternatively, DE 10 2017 112 594 A1 already discloses, for example, systems for mixing and distributing air in aircraft cabins, which systems comprise an air distribution line extending substantially in the longitudinal direction of a cabin and connected in a fluid-tight manner. From single-piece air distribution lines of this type, additional small air distribution pipes then branch off into the aircraft cabin.

Aircraft typically undergo regular maintenance cycles. During maintenance, the structure of the fuselage often also has to be inspected, i.e., checked for imperfections of any type. For this purpose, elements installed in the fuselage interior might have to be dismantled in a time-consuming manner and temporarily removed to allow access to the points which are correspondingly to be inspected for the inspection step. In the case of the above-mentioned air distribution lines, this can mean considerable outlay.

The problem addressed by the present invention is that of indicating a method for using an air distribution system in a fuselage which allows easier and less complex maintenance or inspection of the fuselage.

### SUMMARY OF THE INVENTION

The problem addressed by the invention is solved by a method for using an air distribution system in a fuselage, comprising the following method steps: providing an air distribution system which has an air distribution line, which is formed at least in part from a fluid-tight and flexible material, wherein the air distribution line can switch from a first state in which the flexible material is substantially taut, to a second state in which the flexible material is substantially slack; arranging the air distribution line in a place of installation in the fuselage; occupying the first state of the air distribution line in order to operate the air distribution system; or occupying the second state of the air distribution line in order to carry out maintenance in a spatial region near the place of installation. The method, according to the invention, takes advantage of the fact that the air distribution line, as a result of the character thereof, can reduce the volume thereof by letting out air. In this manner, access to fuselage structures otherwise located behind the air distribution line can be ensured locally or over larger spatial regions, and thus maintenance to the fuselage can be made easier and less complex. Preferably, the air distribution line can therefore switch back and forth from the first state in which the flexible material is substantially taut, to a second state in which the flexible material is substantially slack. During the operation of the air distribution system, the first state is correspondingly occupied. In order to carry out maintenance in or inspect a spatial region near the air distribution line, the second state is occupied. To a certain extent, the second state can be considered an interruption to the first (operating) state.

This is possible, in principle, since the air distribution line is formed at least in part from a fluid-tight and flexible material. This is because the shape thereof is flexible and malleable. This means that, in a (first) compressed state (when air is conducted throughout the air distribution system into the aircraft cabin during operation for air-conditioning and supply purposes), the air distribution line generally takes up the full volume thereof. The full cross section of the air distribution line is then typically filled up, and the flexible material is taut. However, in the (second) uncompressed state (during maintenance or inspection) the shape of the air distribution line can change in principle, and the volume thereof can decrease. The cross section of the air distribution line can then be reduced, and the flexible material is then slack.

The advantageous access during the second state can take place locally as described above, that is to say, it is possible, for example, for only a relatively small reduction in volume to take place in the air distribution line, and thus the corresponding access is limited locally (e.g., for the size of what is known as a “manhole”, i.e., an opening through which a person/worker passes). Access can alternatively also take place over larger spatial regions (by means of a correspondingly larger reduction in volume). By way of example, a reduction in the volume of the air distribution line can take place over the length of a plurality of rows of seats so that substantial regions of the structure located behind the air distribution line can be uncovered and inspected and maintenance can be carried out thereon.

In principle, air distribution lines can advantageously be adapted to the available installation space or the available volume as a result of the fact that they are formed from a fluid-tight and flexible material. Deformations to the fuselage structure as a result of load can also be well absorbed or compensated for. In principle, the flexible material can have an additional insulation layer or can be provided with such.

By means of the method according to the invention, access to regions behind an air distribution line can advantageously be ensured without having to completely dismantle and remove the line. Larger parts of a single air distribution line (as in the prior art) are thus prevented from having to be dismantled.

In one preferred method variant, the first state is achieved by compressing with air from the air distribution system. The compression with air from the air distribution system has proven to be straightforward and effective.

A likewise preferred method variant is characterized in that the second state takes place by letting air out of the air distribution system. Letting air out of the air distribution system is, in principle, possible by opening valves of the air distribution system and is therefore easy to implement.

Preferably, in another method variant, a region above an overhead luggage compartment can be selected as the place of installation, and the air distribution line is arranged therein. This place of installation above the overhead luggage compartments has proven in practice to be suitable for conducting air. Furthermore, such a place of installation is particularly efficient with respect to ensuring access to the region behind the air distribution line.

In an alternatively preferred method variant, a ceiling region of an upper deck of the fuselage is selected as the place of installation, and the air distribution line is arranged therein. When the air distribution line is arranged in the ceiling region (that is to say, for example, directly in the region of the cabin ceiling at the highest point of the cabin), then the advantageous access can be achieved in a particularly simple manner in that, for example, cabin ceiling covers can be removed, and thus the air distribution line can be reached directly, and the air is subsequently let out. Extensive preparatory work for reaching the air distribution line is thus no longer required. In practice, in this manner, for example, the fuselage primary structure behind the air distribution line can be made accessible. It is thus possible to provide access to various antennae arranged in the region of the fuselage structure.

Likewise alternatively, a method variant is preferred in which a triangular region of a lower deck of the fuselage is selected as the place of installation, and the air distribution line is arranged there. In the case of such an arrangement, in principle, use is made of the same advantages as in the above-described method variants. In the lower deck of an aircraft, such as a cargo deck, that is to say, in a region of the fuselage underneath an intermediate floor, there are conventionally two regions known as triangular regions. In a cross-sectional view of the aircraft, these regions are each defined by the outer structure of the fuselage (for example frames and stringers), the cross beams of the intermediate floor (for example the supports of the intermediate floor) and what are known as Z struts, which conventionally extend vertically between a support of the intermediate floor and a frame, and are usually located on both sides of the aircraft. The Z struts are used, in particular, to support the intermediate floor in the vertical direction and to reinforce the aircraft structure underneath the intermediate floor. The triangular regions are often used to lay lines in the longitudinal direction of the aircraft. Normally, there are no interfering components arranged in the triangular regions, in particular in the transverse direction of the aircraft, and, therefore, lines can be laid from the nose to the tail of the aircraft, or at least from the airfoils to the nose or to the tail of the aircraft in the triangular regions. The triangular region is therefore suitable for arranging an air-conducting air distribution line according to the invention.

Particularly preferably, a woven material is used as a fluid-tight and flexible material. Woven materials have proven expedient in practice and are characterized by a high resistance capacity as well as tightness and residual strength.

Lastly, it is most preferable for the second state to be achieved by generating a negative pressure in the air distribution system. By generating a negative pressure in the air distribution system, the volume of the air distribution line(s) can be reduced to the maximum, and thus maximum use can be made of the effect according to the invention of providing access to otherwise covered regions.

The above-described aspects and additional aspects, features and advantages of the invention can likewise be found in the examples of the embodiment which are described in the following with reference to the accompanying drawings.

### BRIEF DESCRIPTION OF THE DRAWINGS

In the drawings, like reference signs are used for like or at least similar elements, components or aspects. It should be noted that, in the following, embodiments are described in detail which are merely illustrative and non-limiting. In the claims, the word “comprising” does not exclude other elements, and the indefinite article “a” does not exclude a plurality. The mere fact that specific features are mentioned in various dependent claims does not limit the subject matter of the invention. Combinations of these features can advantageously also be used. The reference signs in the claims are not intended to limit the scope of the claims. The drawings are not to scale, but rather are merely schematic and illustrative. In the drawings:

FIG. 1 shows a cross section through a region above an overhead luggage compartment having a taut air distribution line arranged therein,

FIG. 2 shows a cross section through a region above an overhead luggage compartment having a slack air distribution line arranged therein,

FIG. 3 shows a cross section through a ceiling region of an upper deck of a fuselage having a taut air distribution line arranged therein,

FIG. 4 shows a cross section through a triangular region of a lower deck of a fuselage having a taut air distribution line arranged therein,

FIG. 5 shows a schematic flow chart of the method according to the invention, and

FIG. 6 is a perspective view of an aircraft.

### DETAILED DESCRIPTION OF THE PREFERRED EMBODIMENTS

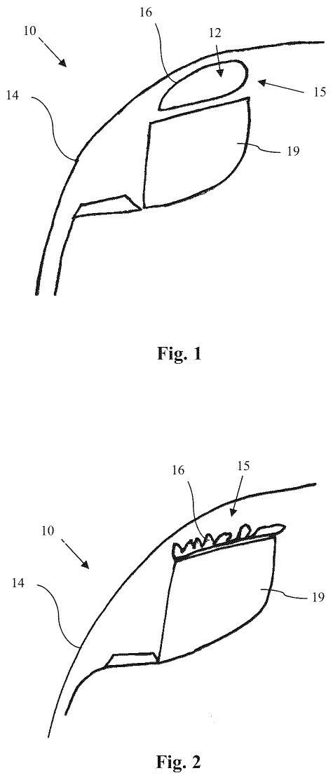

FIG. 1 shows a cross section through a region above an overhead luggage compartment 19 in a cabin of a fuselage 10. The fuselage 10 comprises a fuselage structure having an aircraft outer skin 14. An air distribution system 12 which comprises an air distribution line 16, which is formed at least in part from a fluid-tight and flexible material (for example, a woven material), was produced and arranged in the region 15 above the overhead luggage compartment 19 as the place of installation in the fuselage 10. In FIG. 1, the air distribution line 16 is shown in a first state in which the flexible material is substantially taut. The first state of the air distribution line 16 is occupied in order to operate the air distribution system 12. The first state can be achieved by compressing with air from the air distribution system 12.

This is possible since the air distribution line 16 is formed, at least in part, from the fluid-tight and flexible material. The shape of the line is flexible. In the first, compressed state (when air is conducted via the air distribution system 12 into the aircraft cabin during operation for air-conditioning and supply purposes), the air distribution line 16 takes up the full volume thereof and is thus taut or firm. The full cross section of the air distribution line is then typically filled up, and the flexible material is made taut.

In FIG. 2, the same cross section is shown as in FIG. 1, wherein in contrast therewith, the air distribution line 16 is shown in a second state in which the flexible material is substantially slack. The second state of the air distribution line 16 is occupied in order to carry out maintenance in the region 15 above the overhead luggage compartment 19. The second state can be achieved by letting air out of the air distribution system 12. Alternatively, the second state can be achieved by generating a negative pressure in the air distribution system 12. In the second, uncompressed state (i.e., generally during maintenance) the shape of the air distribution line 16 can change in principle, and the volume thereof can decrease. The cross section of the air distribution line 16 can then be reduced, and the flexible material is then slackened.

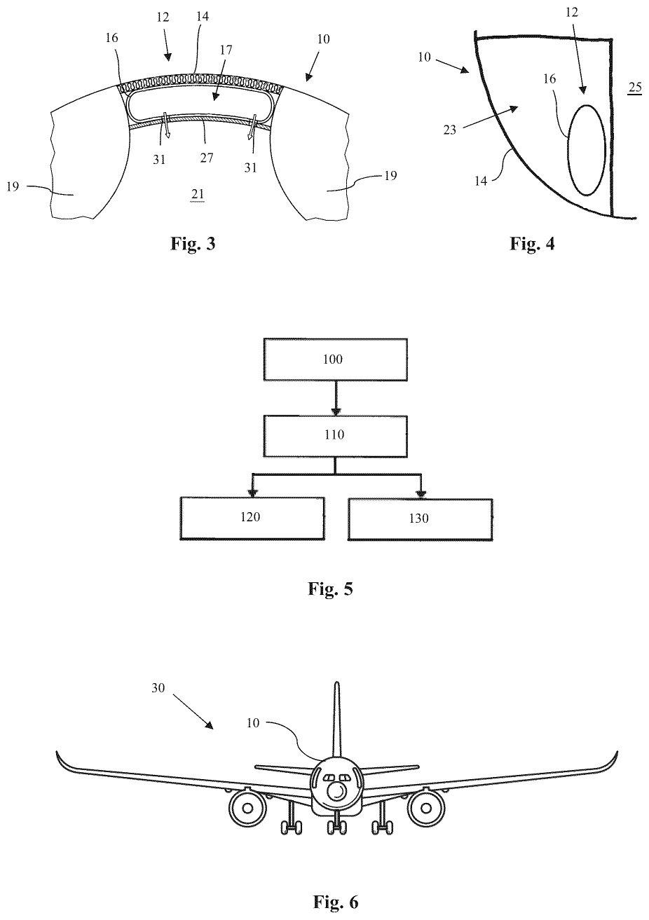

FIG. 3 shows an alternative place of installation for the air distribution line 16, namely a ceiling region 17 of an upper deck 21 of the fuselage 10. The fuselage 10 likewise comprises a fuselage structure having an aircraft outer skin 14. Correspondingly, such a place of installation can be selected for the method, and the air distribution line 16 can be arranged therein. In FIG. 3, the air distribution line 16 is arranged between an upper outer skin 14 of the fuselage 10, two side walls of the overhead luggage compartment 19 and a cabin ceiling 27. In the drawing, two air outlets 31 are shown from the air distribution line 16 through the cabin ceiling 27, through which outlets air can flow out of the air distribution line 16 into the cabin or the upper deck 21 (cf. corresponding arrows).

Alternatively, as shown in FIG. 4, a triangular region 23 of a lower deck 25 of the fuselage 10 can be selected as the place of installation, and the air distribution line 16 can be arranged therein. The fuselage 10 likewise comprises a fuselage structure having an aircraft outer skin 14.

FIG. 5 shows a flow chart which represents the method according to the invention for using an air distribution system 12 in a fuselage 10. The method comprises the following method steps: providing 100 an air distribution system 12 which has an air distribution line 16, which is formed at least in part from a fluid-tight and flexible material, wherein the air distribution line 16 can switch from a first state in which the flexible material is substantially taut to a second state in which the flexible material is substantially slack, arranging 110 the air distribution line in a place of installation 15, 17, 23 in the fuselage 10, occupying 120 the first state of the air distribution line 16 in order to operate the air distribution system 12, or occupying 130 the second state of the air distribution line 16 in order to carry out maintenance in a spatial region near the place of installation 15, 17, 23.

FIG. 6 lastly shows an aircraft 30 comprising a fuselage 10, in which the method according to the invention can be used to use the air distribution system 12 in a fuselage 10.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for using an air distribution system in a fuselage, comprising the following method steps:
a) providing the air distribution system,
which has an air distribution line,
which is formed at least in part from a fluid-tight and flexible material,
wherein the air distribution line, is configured to switch from a first state in which the flexible material is substantially taut, to a second state in which the flexible material is substantially slack,
b) arranging the air distribution line in a place of installation in the fuselage, and
c) occupying the first state of the air distribution line in order to operate the air distribution system, or
d) occupying the second state of the air distribution line in order to carry out maintenance in a spatial region near the place of installation.

2. The method according to claim 1, wherein the first state is achieved by compressing with air from the air distribution system.

3. The method according to claim 1, wherein the second state is achieved by letting air out of the air distribution system.

4. The method according to claim 1, wherein a region above an overhead luggage compartment is selected as the place of installation, and the air distribution line is arranged therein.

5. The method according to claim 1, wherein a ceiling region of an upper deck of the fuselage is selected as the place of installation, and the air distribution line is arranged therein.

6. The method according to claim 1, wherein a triangular region of a lower deck of the fuselage is selected as the place of installation, and the air distribution line is arranged therein.

7. The method according to claim 1, wherein a woven material is used as the fluid-tight and flexible material.

8. The method according to claim 1, wherein the second state is achieved by generating a negative pressure in the air distribution system.
